(19) United States
(12) Patent Application Publication
(10) Pub. No.: US 2006/0143317 A1
(43) Pub. Date: Jun. 29, 2006

(54) Starting method of wireless input apparatus and the apparatus thereof

(75) Inventor: Guo Cheng Shie, Taipei (TW)

Correspondence Address: G. LINK Co., LTD;Suite 137, PmB174, 931 West, 75th Street, Naperville, IL, 60565, US

(73) Assignee: BEHAVIOR TECH COMPUTER CORP.

(21) Appl. No.: 11/021,867

(22) Filed: Dec. 27, 2004

(51) Int. Cl. G06F 3/00

(52) U.S. Cl. 710/8

(57) ABSTRACT

The present invention is disclosed a starting method of wireless input apparatus. Step A is when wireless input apparatus is first installed, wireless input transmitting apparatus will judge if being moved or being depressed by at least one related button, if truth, then it will go forward step B; if false, then wireless input transmitting apparatus will continue to detect if being moved or being depressed by at least one related button. Step B is that wireless transmitting apparatus utilizes the packets with the format of normal data packets containing identification code to transmit toward corresponding wireless input receiving apparatus in the first usage. Step C is that wireless input receiving apparatus starts searching in order to receive the packets of step B. Step D is that wireless input receiving apparatus uses the identification code in the packet of step C and sets as the identification code of wireless input receiving apparatus. Accordingly, from the execution of step A to step D, wireless input transmitting apparatus and wireless input receiving apparatus achieve the pairing.

### FIELD OF THE INVENTION

The present invention is related to a staring method of wireless input apparatus and the apparatus thereof, especially to the method and the wireless apparatus which is capable of reducing the connection button component and using a single format of packet which is used as the packet of ordinary data and also as the packet of the identification code for common usage.

### BACKGROUND OF THE INVENTION

The conventional wireless apparatus like wireless mouse or wireless keyboard is equipped with a connection button on both the transmitting side and receiving side, the user has to follow the instructional procedure to depress the connection button to complete the starting operation while in the first installation. Or the wireless apparatus fails to correctly work in pairing even if the user has installed new batteries on the transmitting side and connected the receiver to the computer host. The object of the conventional wireless apparatus equipped with the connection button is to set up an identification code for common usage between the transmitting side and receiving side, so the related instructions to set up the identification code for common usage is really executed after both the transmitting side and receiving side getting the signal from depressing the connection button by the user.

About the above procedure to set up the identification code for common usage, the prior art has disclosed a specific packet used for this procedure, the transmitter transmits to the receiver the packets composed of this special format which contains the identification code for common usage. However, the packet with special format fails to be the packet used for ordinary data, the data produced by operating the transmitter like the data of cursor movement utilizes another format of packet to form the data packet to transmit toward the receiver after the identification code for common usage being set between the transmitting side and receiving side.

The above prior art in order to set up an identification code for common usage between the transmitting side and receiving side and then to add the connection button and special format of packet for this purpose increases manufacturing cost for wireless input apparatus and also makes the related firmware for running wireless input apparatus more complex.

The inventor of the present invention investigates the disadvantage of the above prior art and invents to improve a starting method applied for wireless input apparatus and the apparatus thereof to reduce the connection button and use a single format of packet which is used as the packet of ordinary data and also as the packet of the identification code for common usage.

### SUMMARY OF THE INVENTION

The object of the present invention is to provide a starting method of wireless input apparatus and the apparatus thereof which is capable of only moving wireless input transmitting apparatus or depressing the arbitrary related button to automatically complete the set up of the identification code for common usage by wireless input apparatus in the first installation by the user.

To achieve the above object, the present invention provides a starting method of wireless input method which comprises the following steps:

Step A: when wireless input apparatus is first installed, wireless input transmitting apparatus will judge if being moved or being depressed by at least one related button, if truth, then it will go forward to step B; if false, then wireless input transmitting apparatus will continue to detect if being moved or being depressed by at least one related button;

Step B: wireless transmitting apparatus utilizes the packets with the format of normal data packets containing identification code to transmit toward corresponding wireless input receiving apparatus in the first usage;

Step C: wireless input receiving apparatus searches the packets of step B and receives the packets of step B; and

Step D: wireless input receiving apparatus uses the identification code in the packet of step C and sets as the identification code of wireless input receiving apparatus.

Therefore, wireless input transmitting apparatus and wireless input receiving apparatus achieve the pairing.

Furthermore, to achieve the above invention object, the present invention provides a wireless input apparatus to implement the stating method of the present invention.

### BRIEF DESCRIPTION OF THE DRAWINGS

The above objects and advantages of the present invention will become more apparent with reference to the appended drawings wherein:

FIG. 1 shows the flow diagram of the present invention;

FIG. 2 shows the illustrative figure of first starting wireless input apparatus in using status;

FIG. 3 shows the block diagram of wireless mouse applying the present invention;

FIG. 4 shows the block diagram of wireless mouse receiver applying the present invention; and

FIG. 5 shows the data structural diagram of normal data packet used in wireless input apparatus.

### DETAILED DESCRIPTION OF THE INVENTION

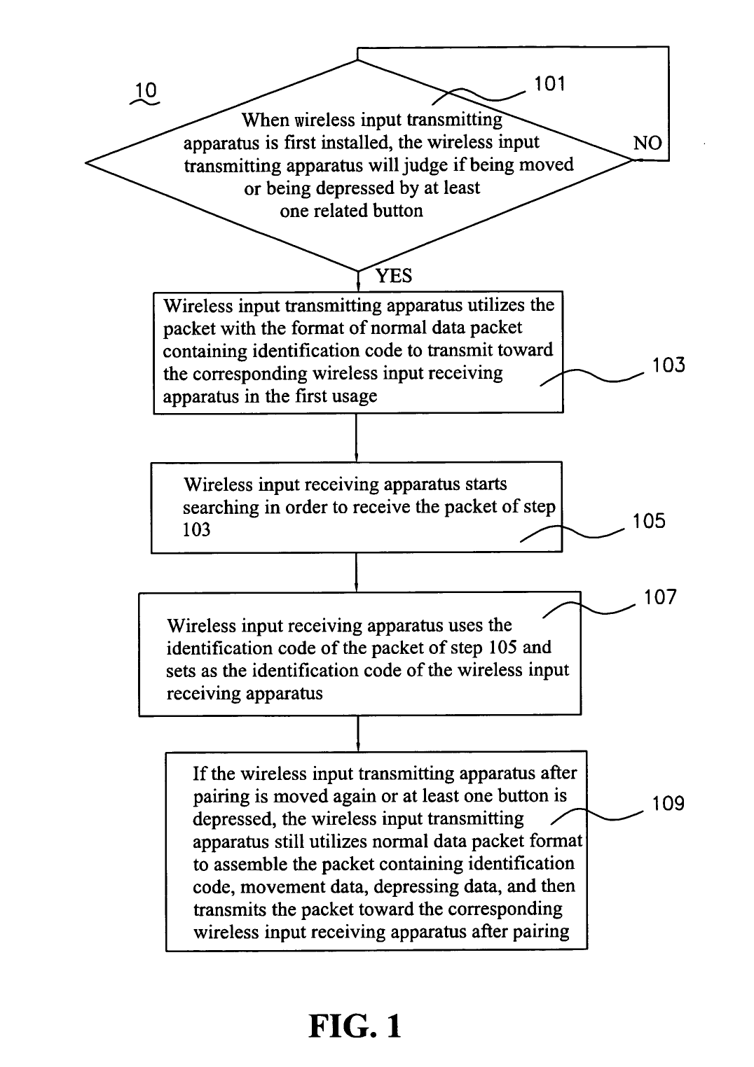

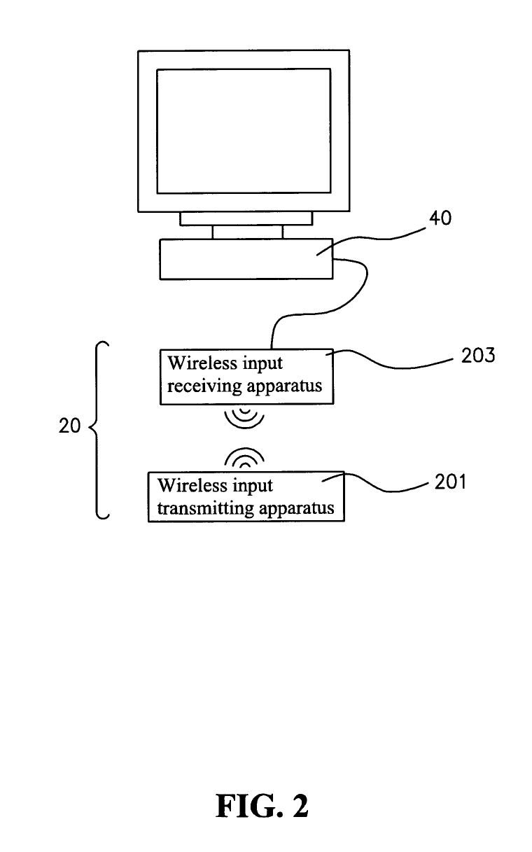

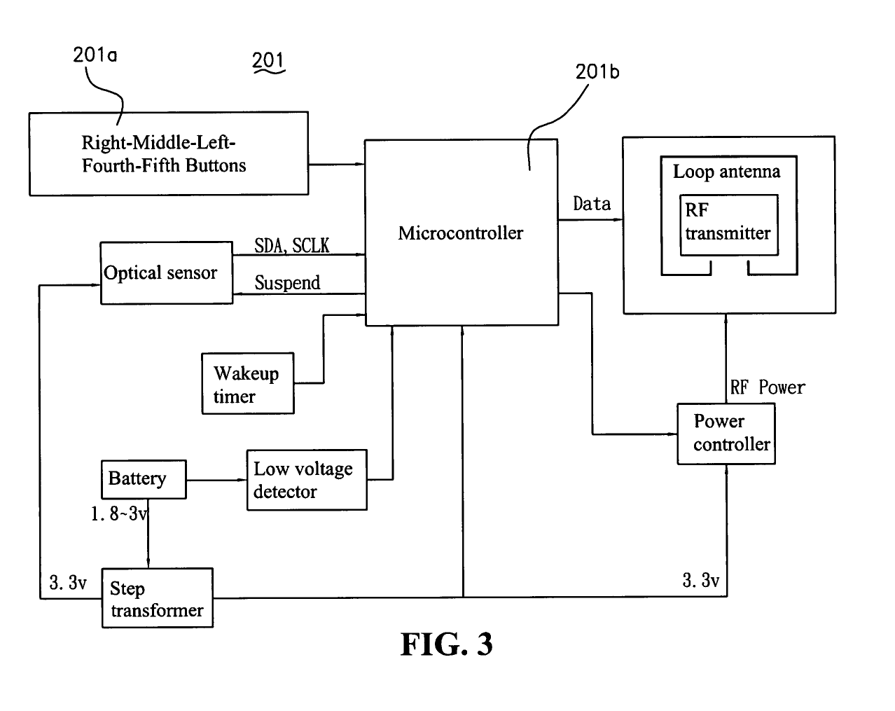

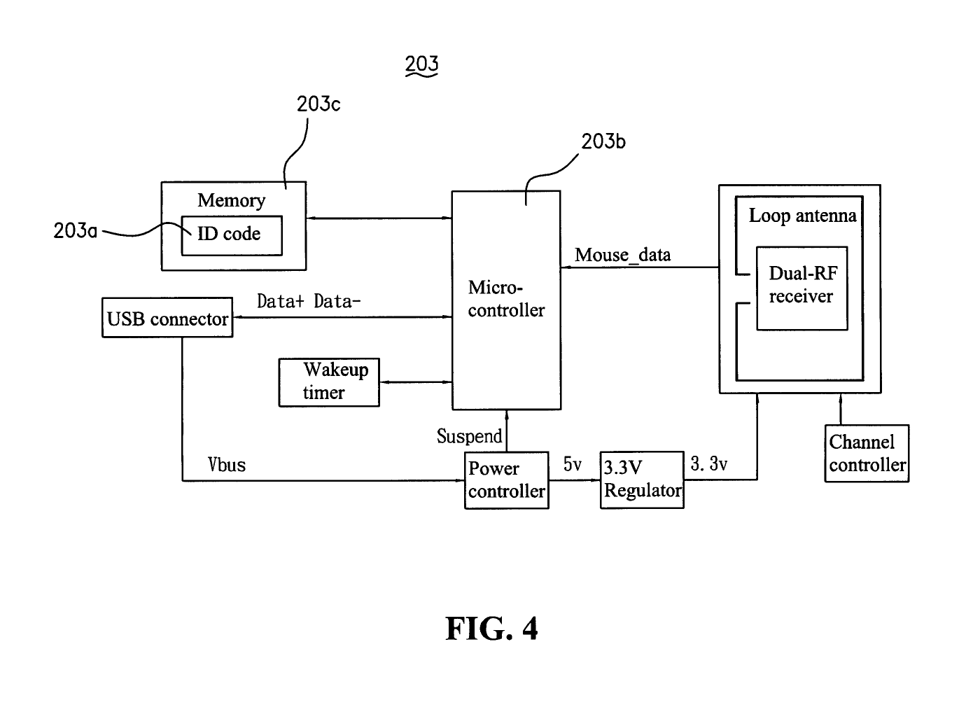

FIG. 1 shows the flow diagram of the present invention. The starting method 10 of the present invention is mainly used in wireless input apparatus 20, particularly when the user installs and starts wireless input apparatus 20 in the first time, referring to FIG. 2, it shows the illustrative figure of first starting wireless input apparatus in using status. By the aid of the embodiment of the present invented means 10, the first installed and starting wireless input apparatus 20 is capable of easily operated to offer the user to complete the paring usage of wireless input apparatus 20. The following content will disclose detailed steps of starting method 10 and also refer to FIG. 3 of showing the block diagram of wireless mouse applying the present invention and FIG. 4 of showing the block diagram of wireless mouse receiver applying the present invention. When the user equips the new battery into the wireless input apparatus 201 and connects wireless mouse receiver 203 in the first time to the computer 40, wireless input apparatus 20 executes soon step 101 to step 107.

Step 101 is when wireless input transmitting apparatus 201 is started in the first time, wireless input transmitting apparatus 201 is judged if being moved or at least one button 201a being depressed, if truth, then it will go forward step 103; if false, then wireless input transmitting apparatus 201 continues to detect if being moved or at least one button 201a being depressed. When wireless mouse 201 is equipped with new batteries, the user is only to move wireless mouse 201 or to depress one of buttons 201a, then microcontroller 201b will automatically detect wireless mouse 201 to be moved or detect buttons 201a to be depressed. If the signal variation is detected, wireless mouse 201 will take the signal variation as the staring instruction of first installation, and then wireless mouse 201 has to go forward the pairing with wireless mouse receiver 203.

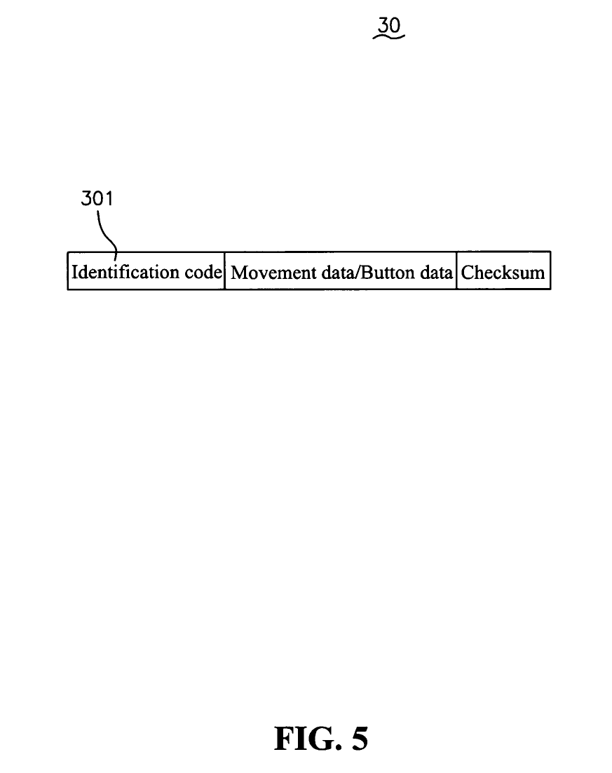

Step 103 is that wireless input transmitting apparatus 201 utilizes normal data packet format containing the packet 30 with identification code 301 and transmits the packet 30 toward the corresponding and first used wireless input receiving apparatus 203. Referring to FIG. 5 showing the data structural diagram of normal data packets used in wireless input apparatus, wireless input apparatus 20 utilizes normal data packet 30 packed in a single format as the following usage:

A. containing the identification code 301 in the first staring usage;

B. wireless input transmitting apparatus 201 after completing the starting procedure produces the information like movement data, depressing data by the user's operation. Wireless mouse 201 in step 103 utilizes the normal data packet format instead of another kind of packet used for setting communicative identification code to assemble the packet 30 with identification code 301.

Step 105 is that wireless input receiving apparatus 203 starts searching to receive the packet 30 of step 103. Wireless input receiving apparatus 203 in step 105 is in the first starting stage, wireless input receiving apparatus 203 is capable of using frequency hopping to receive the packet 30 transmitted in step 103. Since wireless mouse 201 itself possesses the option of multiple transmitting frequencies, wireless mouse 201 utilizes one of transmitting frequency to transmit the packet 30 and then wireless mouse receiver 203 assures to receive the packet 30 to use frequency hopping for searching.

Step 107 is that wireless input receiving apparatus 203 utilizes the identification code 301 in the packet 30 of step 105 and sets as identification code 203a for wireless input receiving apparatus 203. In step 107 of wireless mouse receiver 203, microcontroller 203b catches identification code 301 of the packet 30 and sets identification code 203a by equivalent value of identification code 301 to complete the paring for wireless mouse 201 and wireless mouse receiver 203 in the first installation. Furthermore, wireless mouse receiver 203 is capable of including non-volatile memory 203c to store readily set identification code 203a.

Furthermore, the present invented starting method 10 comprises step 109, the step is that wireless input transmitting apparatus 201 being moved again or at least one button 201a being depressed after paring still utilizes normal data packet format of the packet 30 containing identification code, movement data, and button data, and transmits the packet 30 toward corresponding wireless input receiving apparatus 203 after pairing. After executing from step 101 to step 107 by wireless input apparatus 20, wireless input apparatus 20 enters soon step 109, and then the user operates in next time, both wireless input transmitting apparatus 201 and receiving apparatus 203 directly execute step 109. In step 109 of the wireless mouse 201 and wireless mouse receiver 203, the user manipulates wireless mouse 201 to input instructions into the computer, and wireless mouse 201 also utilizes normal data packet format of the packet 30 containing identification code, movement data and button data to transmit toward the corresponding wireless mouse receiver 203. Meanwhile, wireless mouse receiver 203 receives and processes the packet 30 to conduct the packet 30 toward the computer.

In order to adjust the communication distance between wireless input transmitting apparatus 201 and corresponding wireless input receiving apparatus 203 in the first starting of wireless input apparatus 20, the above step 103 comprises the step of setting the transmitting power of wireless input transmitting apparatus 201 to adjust the effective range of the packet 30 transmitted by wireless input transmitting apparatus 201. Meanwhile, the above step 105 comprises the step of setting the receiving power of wireless input receiving apparatus 203 to adjust the effective range of capably receiving the packet 30 of step 103 transmitted by wireless input receiving apparatus 203. The present invented starting method 10 utilizes the adjustment of transmitting power or the adjustment of receiving power to make the user more convenient to designate effectively operating range for wireless input apparatus 20.

The above identification code 301 of the present invention is produced by random number of wireless input transmitting apparatus 201, for instance, microcontroller 201b is processed to produce identification code 301 by random number.

The present invention uses wireless mouse 201 and wireless mouse receiver 203 as the embodiment, however, it does not imply the limitation by the embodiment, the present invented starting method 10 is capable of being applied to other kind of wireless input apparatus like wireless keyboard, wireless joystick and so on.

The present invented starting method 10 is capable of using firmware means to implement wireless input apparatus 20, for example, step 101, step 103 and step 109 are executed by another firmware program running in microcontroller 201b of wireless mouse 201. Similarly, step 105 and step 107 are executed by a firmware program running in microcontroller 203b of wireless mouse receiver 203.

Although the present invention has been disclosed some embodiments as the above, it does not imply to limit the present invention, any person who is skilled the art could make any change or modification within the spirit and scope of the present invention, and any change or modification is within the scope of the following claims of the present invention.

What is claimed is:

1. A starting method of wireless input apparatus, comprising the steps:
A. when a wireless input transmitting apparatus is first installed, the wireless input transmitting apparatus will judge if being moved or being depressed by at least one related button, if truth, then it will go forward to step B; if false, the wireless input transmitting apparatus will continue to detect if being moved or being depressed by at least one related button;
B. the wireless input transmitting apparatus utilizes the packet with the format of normal data packet containing identification code to transmit toward a corresponding wireless input receiving apparatus in the first usage;
C. the wireless input receiving apparatus starts searching in order to receive the packet of the step B; and
D. the wireless input receiving apparatus uses the identification code of the packet of the step C and sets as the identification code of the wireless input receiving apparatus,
Therefore, the wireless input transmitting apparatus and the wireless input receiving apparatus achieve the pairing.

2. The starting method of wireless input apparatus according to claim 1, wherein the searching step in the step C is using frequency hopping for searching by the wireless input receiving apparatus.

3. The starting method of wireless input apparatus according to claim 1, wherein the wireless input transmitting apparatus is one of a wireless mouse, a wireless keyboard, or a wireless joystick.

4. The starting method of wireless input apparatus according to claim 1, wherein the wireless input receiving apparatus further comprises a non-volatile memory for storing the identification code.

5. The starting method of wireless input apparatus according to claim 1, wherein the identification code of the step B is produced by random number generated by the wireless input transmitting apparatus.

6. The starting method of wireless input apparatus according to claim 1, wherein the setup procedure of the step D is purposed for the setup usage by the wireless input receiving apparatus only capturing the identification code of the packet.

7. The starting method of wireless input apparatus according to claim 1, further comprising:
E. if the wireless input transmitting apparatus after pairing is moved again or at least one button is depressed, the wireless input transmitting apparatus still utilizes the normal data packet format to assemble the packet containing identification code, movement data, depressing data, and then transmits the packet toward the corresponding wireless input receiving apparatus after pairing.

8. The starting method of wireless input apparatus according to claim 1, wherein the step B further comprises the step of setting the power of the wireless input transmitting apparatus to adjust the effective range of transmitting the packet of the wireless input transmitting apparatus.

9. The starting method of wireless input apparatus according to claim 1, wherein the step C further comprises the step of setting the power of the wireless input receiving apparatus to adjust the effective range of receiving the packet of the step B of the wireless input receiving apparatus.

10. A wireless input apparatus, comprising a wireless input transmitting apparatus and a wireless receiving apparatus, is characterized in that the wireless input apparatus and the wireless receiving apparatus execute respective procedures as follows:
A. when the wireless input transmitting apparatus is first installed, the wireless input transmitting apparatus will judge if being moved or being depressed by at least one related button, if true, then it will go forward to procedure B; if false, the wireless input transmitting apparatus will continue to detect if being moved or being depressed by at least one related button;
B. the wireless transmitting apparatus utilizes the packet with the format of normal data packet containing identification code to transmit toward the corresponding wireless input receiving apparatus in the first usage;
C. the wireless input receiving apparatus starts searching in order to receive the packet of the procedure B; and
D. the wireless input receiving apparatus uses the identification code of the packet of the procedure C and sets as the identification code of the wireless input receiving apparatus,
Therefore, the wireless input transmitting apparatus and the wireless input receiving apparatus achieve the pairing.

11. The wireless input apparatus according to claim 10, wherein the searching procedure in the procedure C is using frequency hopping for searching by the wireless input receiving apparatus.

12. The wireless input apparatus according to claim 10, wherein the wireless input transmitting apparatus is one of the wireless mouse, the wireless keyboard, or the wireless joystick.

13. The wireless input apparatus according to claim 10, wherein the wireless input receiving apparatus further comprises a non-volatile memory for storing the identification code.

14. The wireless input apparatus according to claim 10, wherein the identification code of the procedure B is produced by random number generated by the wireless input transmitting apparatus.

15. The wireless input apparatus according to claim 10, wherein the setup procedure of the procedure D is purposed for the setup usage by the wireless input receiving apparatus only capturing the identification code of the packet and not to transmit the packet forward the connected computer.

16. The wireless input apparatus according to claim 10, further comprising:
E. if the wireless input transmitting apparatus after pairing is moved again or at least one button is depressed, the wireless input transmitting apparatus still utilizes normal data packet format to assemble the packet containing identification code, movement data, depressing data, and then transmits the packet toward the corresponding wireless input receiving apparatus after pairing.

17. The wireless input apparatus according to claim 10, wherein the procedure B further comprises the procedure of setting the power of the wireless input transmitting apparatus to adjust the effective range of transmitting the packet of the wireless input transmitting apparatus.

18. The wireless input apparatus according to claim 10, wherein the procedure C further comprises the procedure of setting the power of the wireless input receiving apparatus to adjust the effective range of receiving the packet of procedure B of the wireless input receiving apparatus.
